(19) United States
(12) Patent Application Publication
(10) Pub. No.: US 2011/0319067 A1
(43) Pub. Date: Dec. 29, 2011

(54) Method for Wireless Cell Site Collocation Optimization

(76) Inventors: Jeff Clark Adams, Seattle, WA (US); Philip Godric-Wystan Woods, Seattle, WA (US)

(21) Appl. No.: 13/074,903

(22) Filed: Mar. 29, 2011

Related U.S. Application Data
(60) Provisional application No. 61/341,365, filed on Mar. 29, 2010.

(51) Int. Cl. H04W 4/00

(52) U.S. Cl. 455/422.1

(57) ABSTRACT

A method and system to optimally choose antenna collocation sites in a geographic region for one or more cellular carriers based on a quantified relative measure of site desirability, considering variables such as terrain elevation, ground clutter, RF propagation coverage, proximity to fiber, existing antenna mounting structure load capacity, and market.

### CROSS-REFERENCE TO RELATED APPLICATIONS

This application claims priority under 35 USC section 119e to U.S. Provisional application No. 61/341,365.

### TECHNICAL FIELD

The present invention relates generally to optimal selection and distribution of cell sites for one or more wireless carriers in a geographic region.

### BACKGROUND

Wireless cellular carriers must acquire and maintain cell sites with sufficient geographic density in order to provide seamless cellular coverage in a given customer region. At each site or basestation (BTS), antennas and communications hardware must be installed, configured, and connected to a backhaul communications channel to provide connectivity for voice and data. Cell site infrastructure represents a large capital and recurring cost to the cellular operator, especially since sites are typically leased. In the United States, there are roughly two carriers on average at the same site sharing antenna mounting structures and hardware cabinets, which is referred to as collocation. Collocation has the advantage of cost sharing at the site for the antenna mounting space, hardware cabinet, power, etc. Even if the different wireless carriers do not have an agreement to explicitly share the various costs, the total carrier costs of a collocation site may still be lower since much of the needed site facilities already exist once the first anchor carrier has completed their hardware installations. In short, there is a cost and time advantage to collocate cell sites. Furthermore, in the case of a merger or acquisition involving two wireless carriers, there may no longer be a need to have over-lapping RF coverage, and intentional collocation can be done to reduce costs. Regardless of the reasons for collocating, it would be preferable to use a method or process to optimally choose which sites to collocate multiple carriers onto and to identify which cell sites can be dropped. Since carriers have many thousands of cell sites, such collocation decisions would be difficult and time-consuming without some automated or semi-automated method of analyzing the relevant cell site data in combination with certain coverage and geographic criteria to optimize the choice of collocation site locations within a given region. U.S. Pat. No. 7,693,087 shows a method for the election and optimization of potential hub candidates within a network, but the hub is a data aggregation point, and not a site which necessarily includes a cell site with antennas, as shown in drawings such as FIG. 2 in U.S. Pat. No. 7,693,087 where the hub sites are distinct from the cell sites on the shown towers. Furthermore, there is no attempt to consolidate cell sites based on any RF coverage analysis or criteria which includes a rank of the goodness of a cell site for RF coverage.

### SUMMARY OF THE INVENTION

The invention provides a method and process to organize cell site and geographic information to use as input to an automated or semi-automated method which ultimately identifies the cell sites best suited for collocation based on a set of criteria provided by the user. The embodiments described herein provide preferred methods and processes to use inputs such as coverage criteria, location, proximity to backhaul (e.g., fiber), geographic data, and cell site information to output a collocation table or map indicating the consolidated cell site locations and the resulting wireless coverage.

### BRIEF DESCRIPTION OF THE DRAWINGS

FIG. 1 shows an embodiment of the system where input data is organized onto electronic media and fed into a processing device such as a computer that performs the analyses and process necessary to output an optimized record of cell site collocations, which is preferably displayed in a map form.

FIG. 2 is the flow chart of the process for analyzing and optimizing the collocation. This is one flowchart that is broken into FIG. 2a through FIG. 2L in order to contain portions of the flowchart into single pages.

FIG. 3 provides an example consistent with the process of FIG. 2 of how the process functions for an arbitrary set of cell sites belonging to three different cellular carriers, where it is desired to increase the degree of collocation among the different carriers.

### DETAILED DESCRIPTION OF THE ILLUSTRATED EMBODIMENTS

Embodiments of a system and method for optimal collocation of cell sites within a given geographical region are described. Specific details are described to provide a thorough understanding of embodiments of the invention, but one skilled in the relevant art will recognize that the invention can be practiced without one or more of the specific details, or with other methods, components, materials, etc. Well-known structures, materials, or operations are not shown or described in detail but are nonetheless encompassed within the scope of the invention.

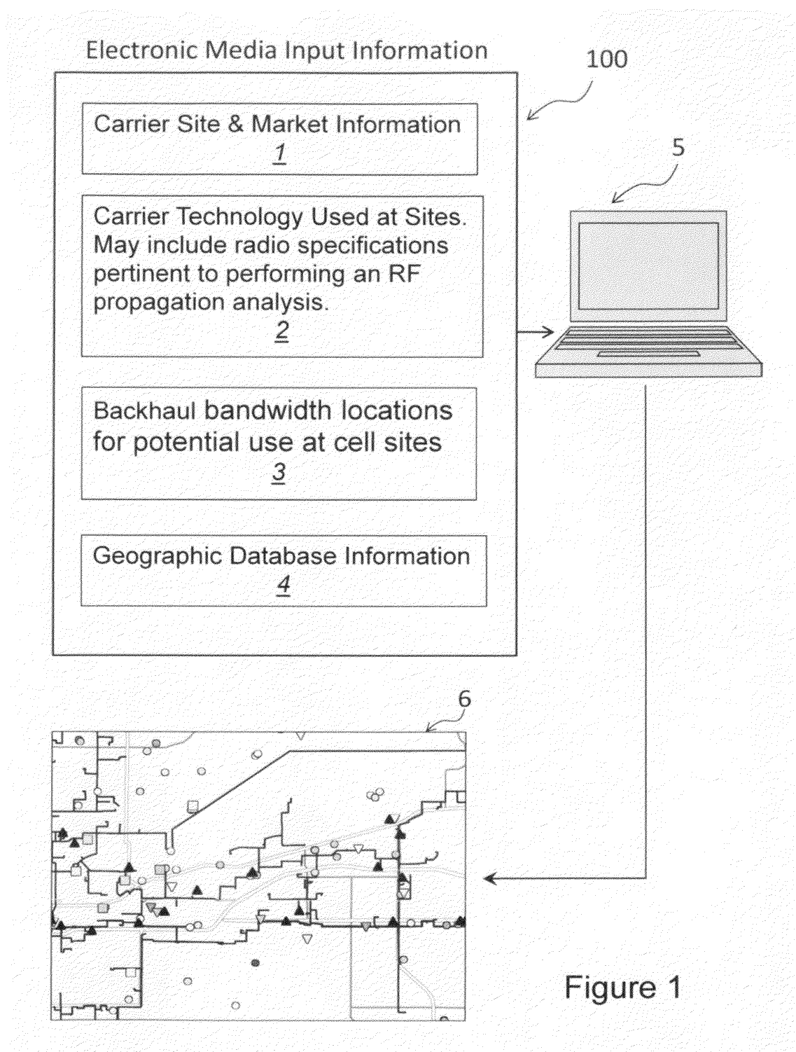

A preferred embodiment in FIG. 1 uses electronically organized input information 100. Carrier site & market information 1 would at a minimum include cell site latitude and longitude or address information, and would preferably further include site structure data such as height, structure type (self-support tower, monopole, rooftop, water tower, telephone pole, etc.), structure loading information (e.g., can the structure handle another 40 lb antenna?), and existing carrier antenna heights. Carrier technology information 2 would preferably include carrier communications hardware specifications such as radio transmit power and/or antenna EIRP (effective isotropic radiation pattern), technology type (GSM, CDMA, LTE, WiMax, etc), frequencies or frequency band, etc. Backhaul capacity is important, so fiber, copper, or microwave backhaul location information 3 would allow each cell site to be ranked for proximity to available backhaul. Finally, geographic information 4 includes digital terrain elevation, above ground clutter (trees, buildings, etc.), water, and anything else important for the calculation of RF propagation.

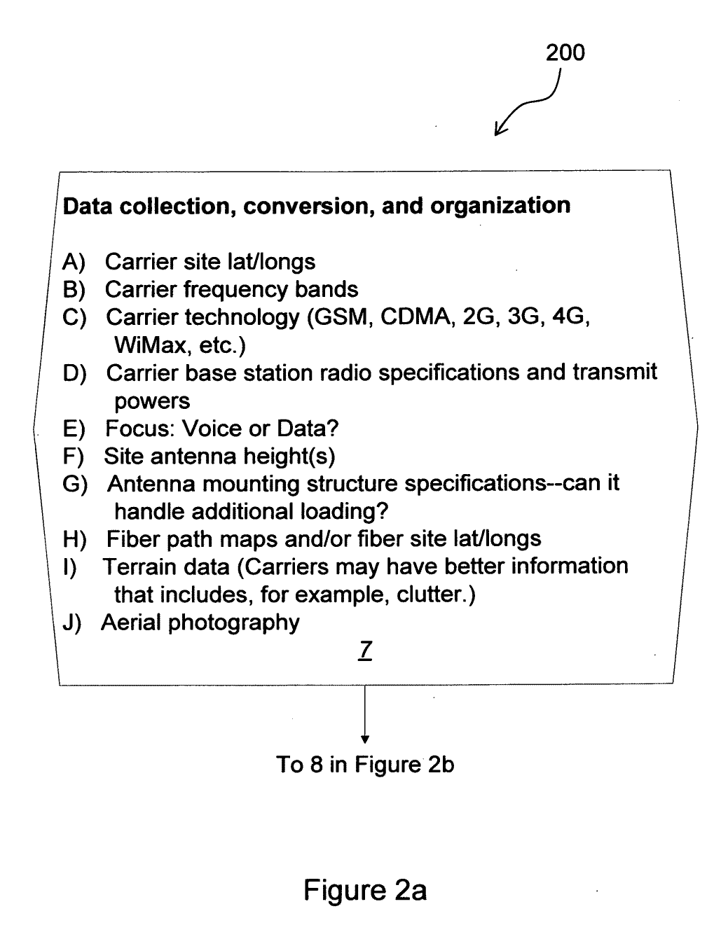

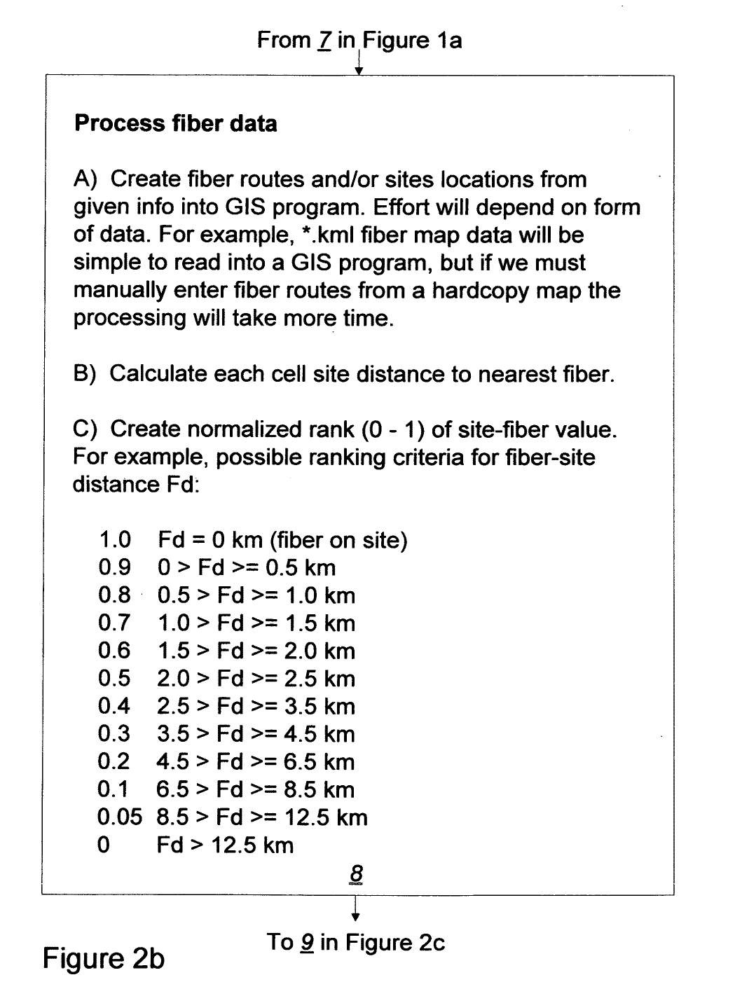

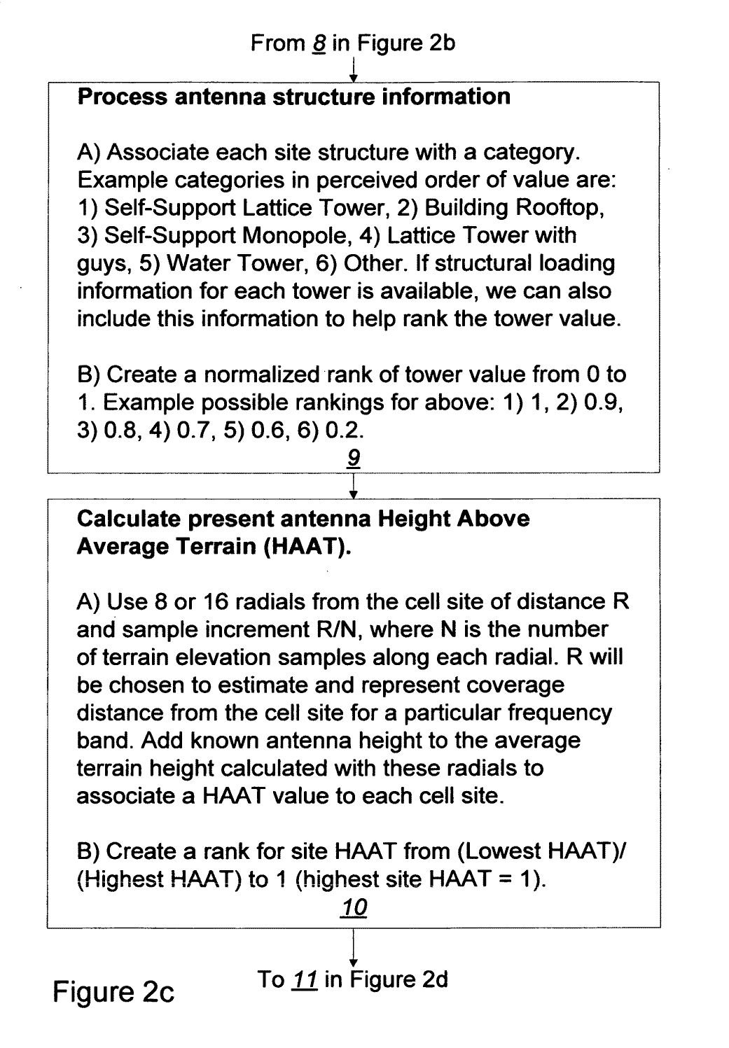

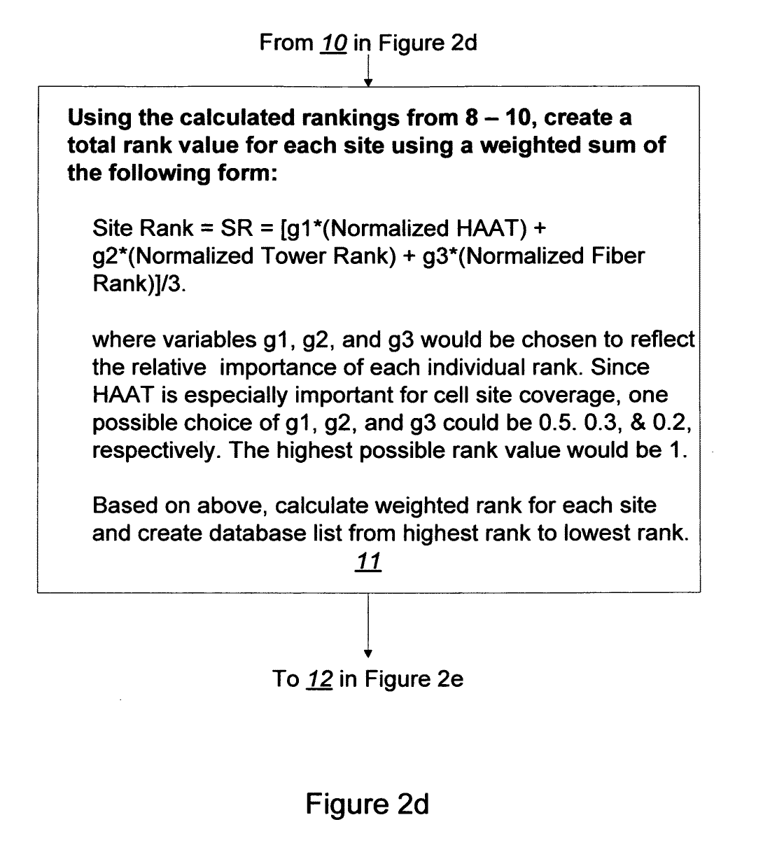

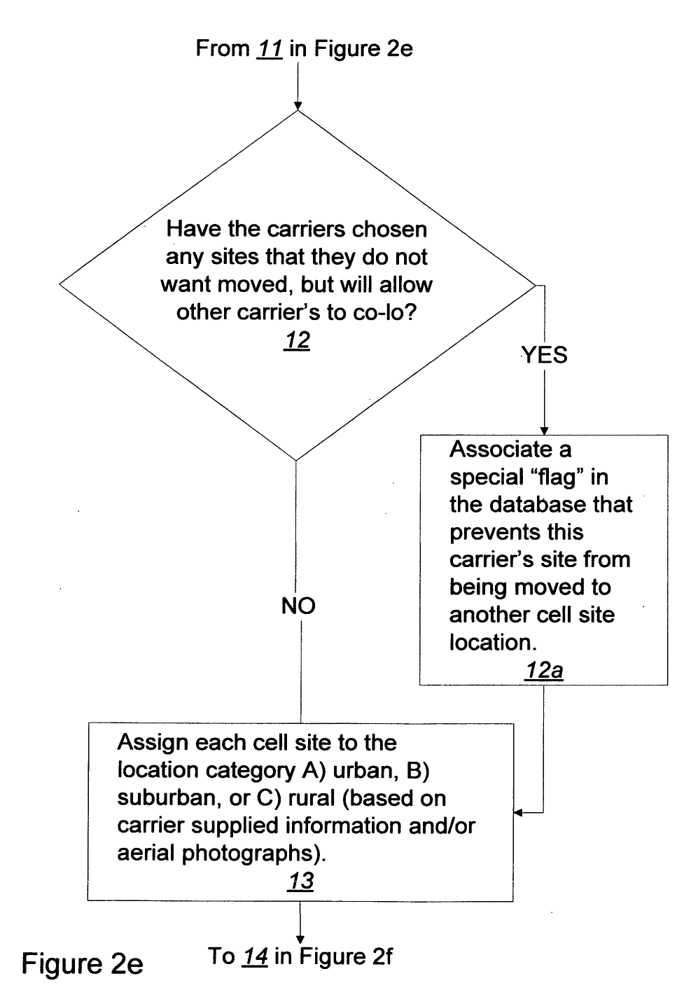

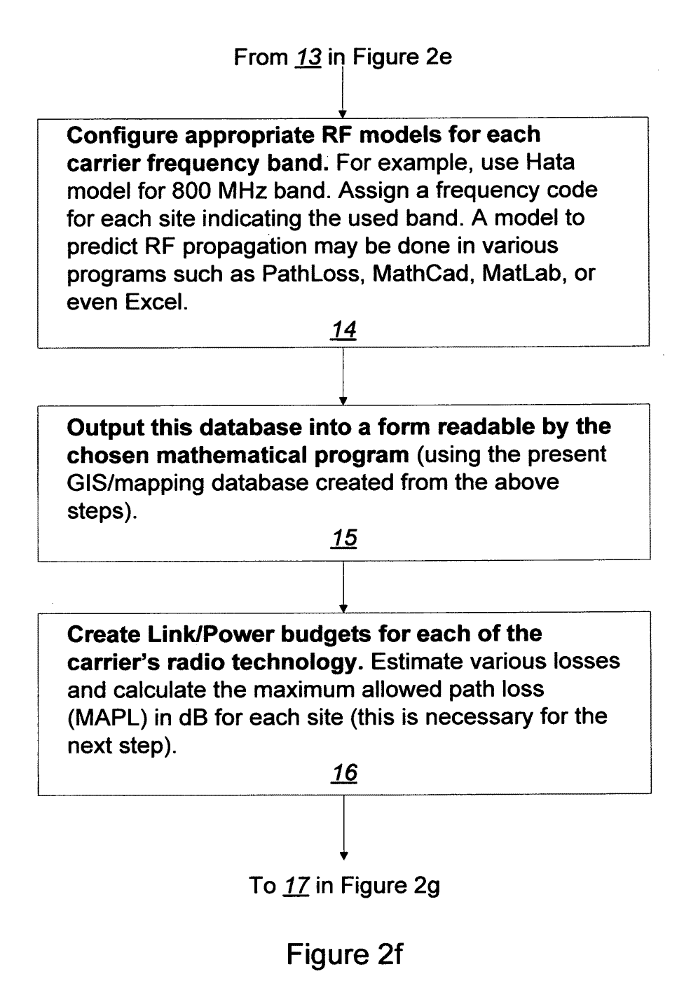

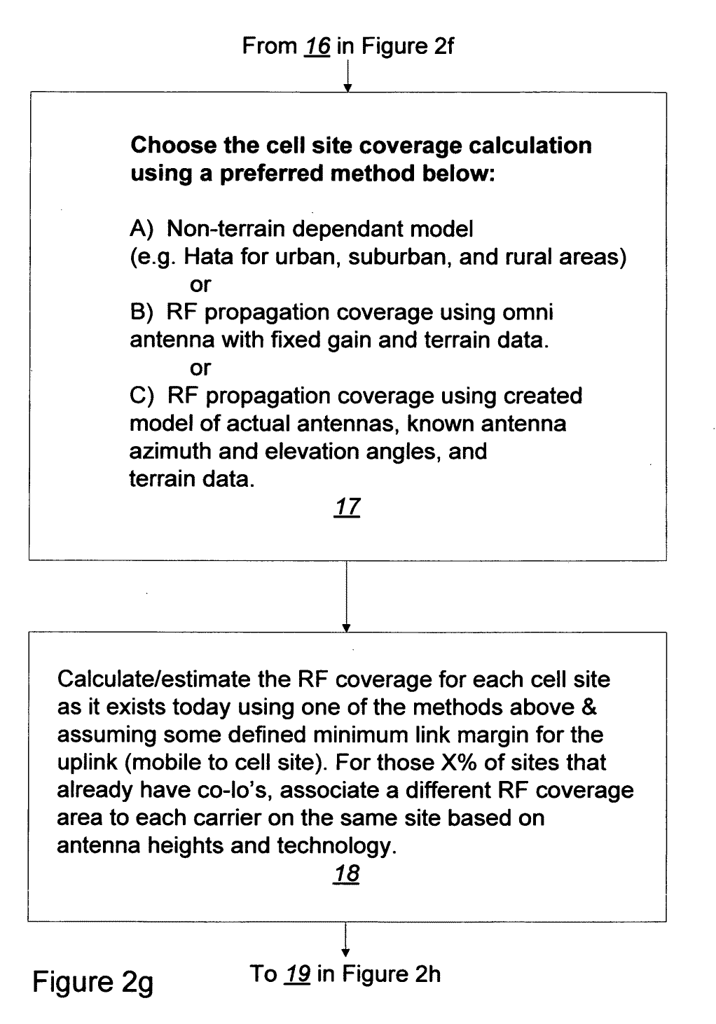

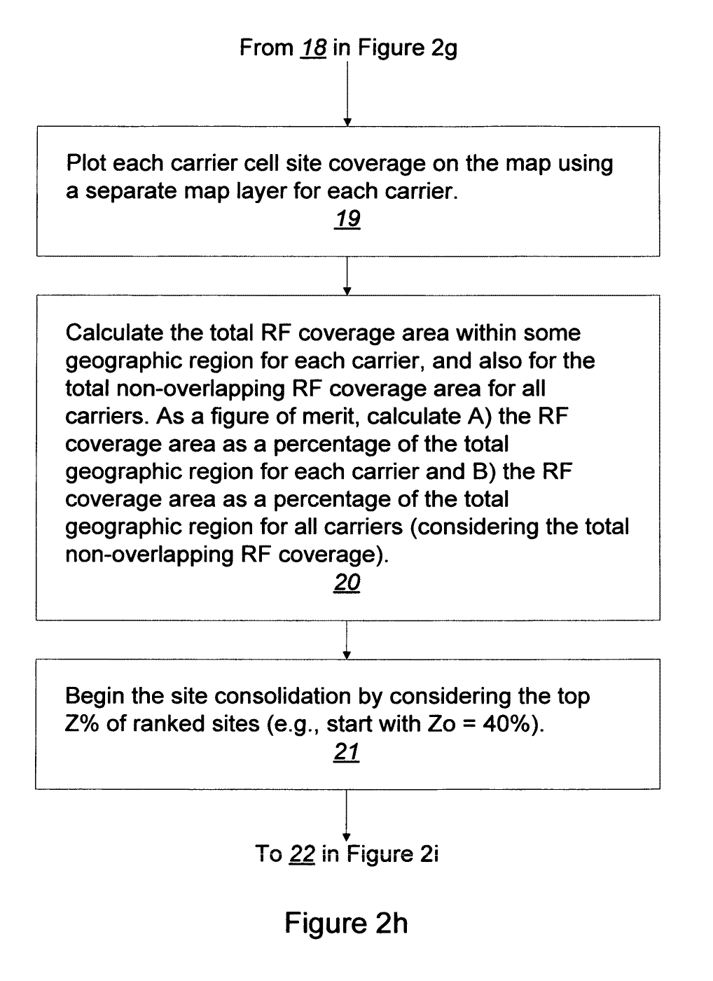

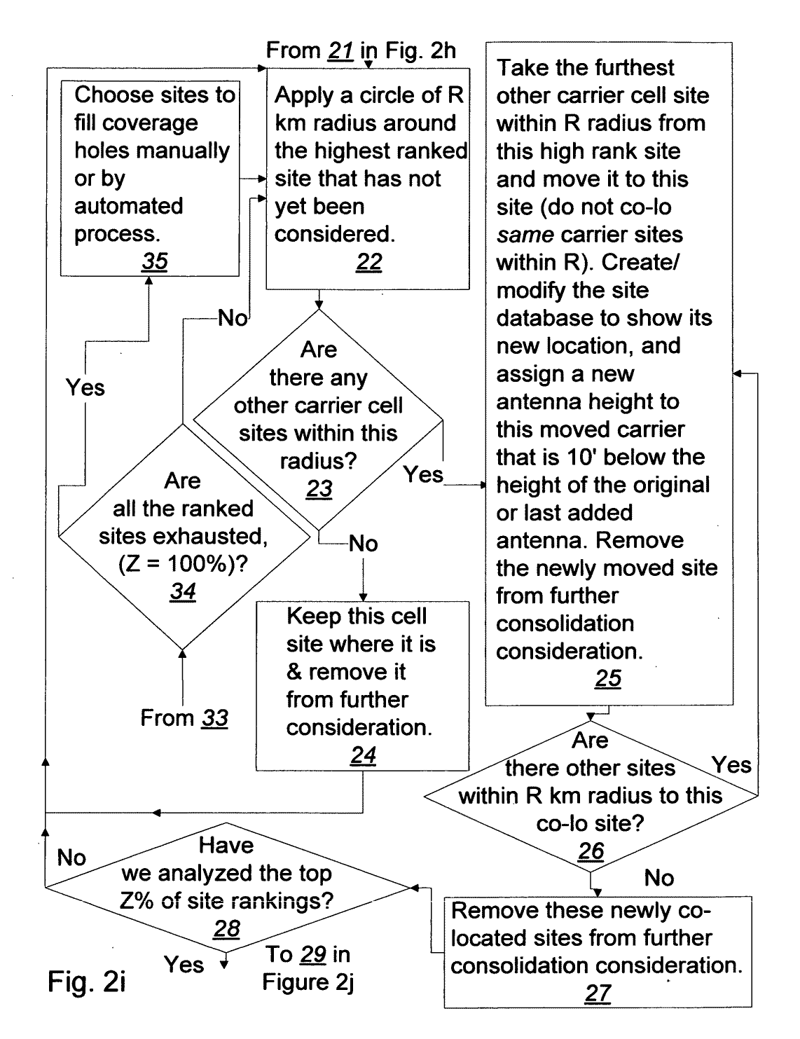

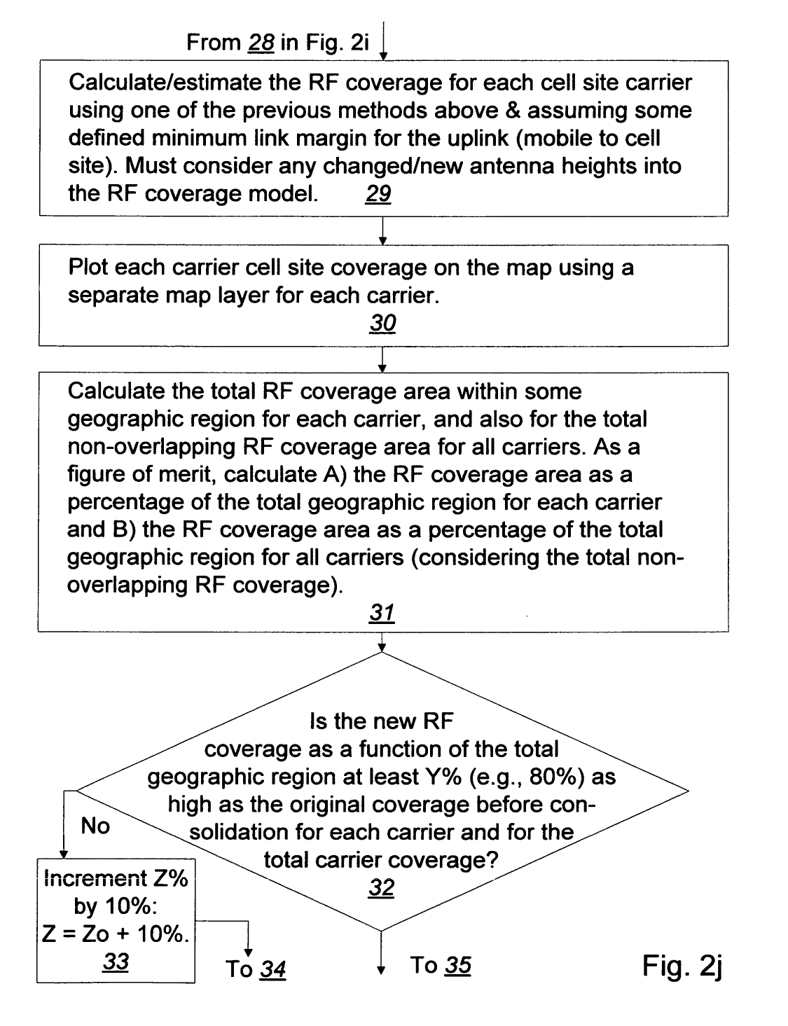

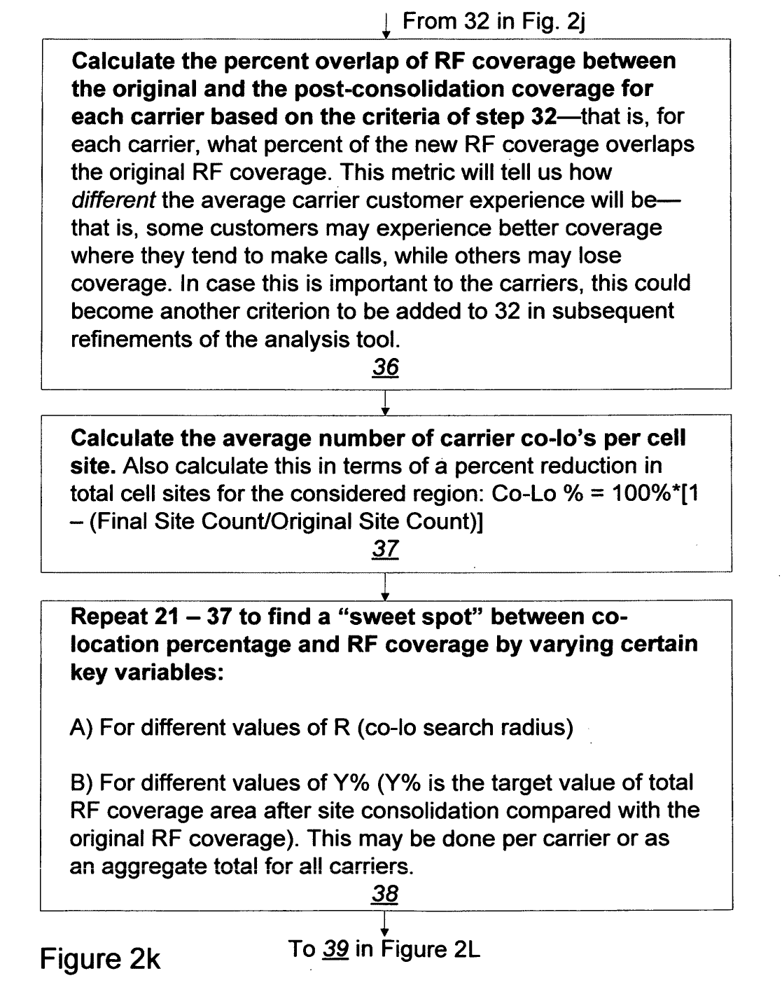

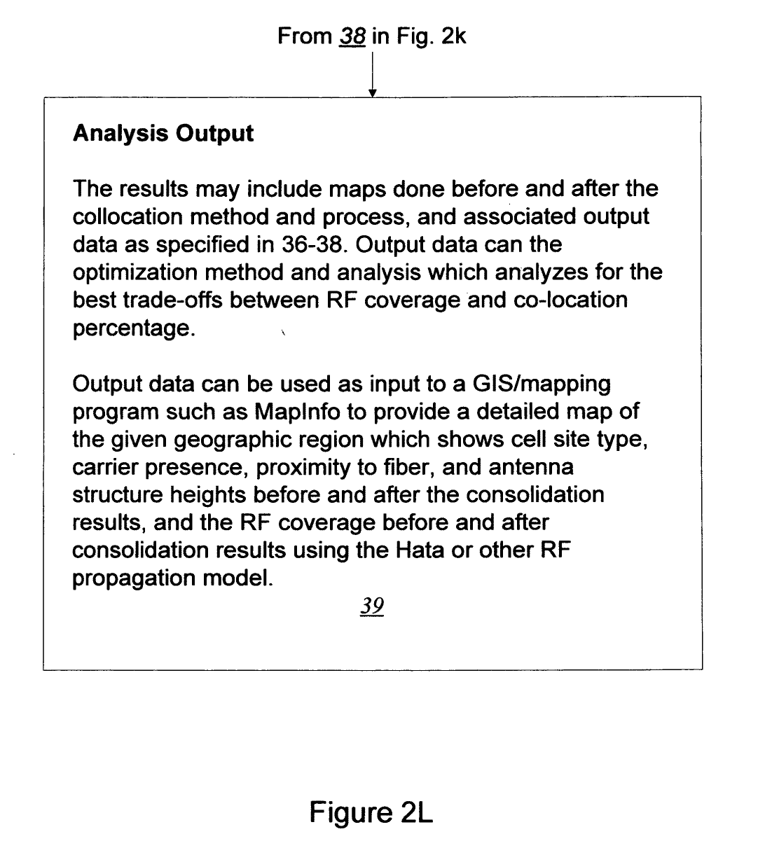

Input information 100 would be electronically input into a device such as a computer 5 to analyze the data by the preferred method given in the process flowchart 200 of FIG. 2 to output a cell site collocation map 6 which shows lines for fiber backhaul, and site icons representing collocation sites, single carrier sites, and other types of sites relevant to the analysis.

Process flowchart 200 begins in FIG. 2a with collecting and organizing the carrier site data 7, including carrier technology and basestation specifications, antenna mounting structure information, backhaul location or maps (e.g., optical fiber), and geographic information such as digital elevation data (can download at www.usgs.gov), and above ground clutter data (e.g., Space Shuttle Radar Topography Mission or SRTM, also available from the USGS). Better clutter information might come from LIDAR data or from a database of geocoded building elevation. Aerial photography may also be used to estimate clutter elevations in a region to aid in any RF propagation modeling.

Process flowchart 200 continues in FIG. 2b to process the fiber data 8. Fiber maps are converted to an electronic form (if not already in this form), and then each cell site under consideration for collocation has a distance calculated to the nearest available fiber. Since it is preferable to have fiber backhaul close to a cell site, a normalized cell site rank is assigned based on this calculated fiber to cell site distance. Since the cost of bringing fiber to a cell site is usually based on distance to the nearest existing fiber, we have proposed a possible preferred ranking, but this can be changed to best reflect the cost of bringing fiber to a cell site in a given region or market. For example, trenching fiber a long distance in an urban area will typically be more expensive than trenching fiber the same distance in a rural area, in which case there could be a higher rank for a 1 mile distance in an urban area than for a 1 mile distance in a rural area.

FIG. 2c shows a preferred processing of the antenna structure data in block 9 and the calculation of the antenna height above average terrain (HAAT) to determine site ranking in block 10. The more substantial antenna mounting structures are preferred, and are ranked accordingly as illustrated in processing block 9. An example tool to calculate HAAT is given in the FCC web site: http://www.fcc.gov/mb/audio/bickel/haat_calculator.html. Since RF propagation coverage is normally larger for a larger HAAT, by calculating HAAT for each cell site under consideration, a rank can be assigned to each site.

FIG. 2d shows a processing block 11 that calculates a total site rank from processing blocks 8-10. This site ranking allows for different weighting to be applied to each attribute as illustrated. The resulting highest ranked sites will be priority sites for collocation.

FIG. 2e shows processing block 12 and 12a which identifies sites that—regardless of collocation desirability based on the rank calculated in block 11—are not to be considered for collocation. One example reason why a carrier may not want to collocate to a site is that the RF coverage from that site may be uniquely favorable, and therefore a carrier might prefer not having a competitor collocated on that particular site. Processing block 13 identifies each cell site as being in one of 3 categories, urban, suburban, or rural. This site associated information may be helpful when performing certain kinds of RF propagation analyses.

FIG. 2f contains processing block 14 which identifies and associates each carrier cell site with a frequency band and an appropriate RF propagation model in an electronic database. A model to predict RF coverage could be done in a specialized program like PathLoss, or using code for a Hata model in a mathematical program like MathCad, MatLab, or even Excel. Processing block 15 translates the generated database created in processing block 14 to be read by a mathematical program to perform an RF coverage analysis for each cell site. Any propagation model will also need to receive and use radio hardware specifications such as transmit power and receiver sensitivity to feed into a calculation of maximum allowed path loss as part of the propagation modeling set-up as illustrated in processing block 16.

In FIG. 2g, processing block 17 shows three preferred RF coverage models that may be used, and processing block 18 specifies that each carrier site shall have a coverage area calculated and associated with each site and each carrier. If there are two different carrier technologies at a single site then two RF coverage maps will be created and associated with each carrier at that site.

In FIG. 2h, processing block 19 takes the coverage area calculated in the previous steps and plots these areas in a mapping program such as MapInfo. If possible, use different layers in the program for each carrier so that a carrier's aggregate RF coverage can be viewed independently from the other carriers if desired. Processing block 20 calculates the total RF carrier coverage area in a given geographic region and further calculates what percentage of the total region under consideration (e.g., a county) is successfully covered. This is done for each wireless carrier and for all carriers under consideration in that region. Processing block 21 begins the collocation process by first choosing the top Z % of ranked cell sites. The collocation analysis may be iterative, and it may be found that a certain percentage of top ranked sites is best to start the process; for example, taking into consideration only the top Z=40% of cell sites as collocation candidates.

Processing block 22 in FIG. 2i begins the analysis by taking the highest ranked cell site and applying a circle of radius R km around the site to look for other candidate cell sites that could be collocated to the high ranking cell site. The choice of R may depend in part on whether the area is urban, suburban, or rural and on the carrier technology, but one preferred initial assumption might be R=2.5 km. Note that a larger R will force a higher degree of collocation, though possibly at the expense of total RF coverage area. Therefore, R=2.5 km may be a starting point, and depending on the output results, one might go back and re-calculate for R=1 km in order to force less collocation and better total RF coverage. This trade-off between total coverage area and collocation degree could be explored by iterating with multiple choices for R. If processing block 23 indicates that other cell sites are in this circle of radius R around the top ranked site, then other cell sites will be collocated to the highest ranked site via processing blocks 24, 25, 26, 27, and 28 with changes in the database to indicate a moved/collocated cell site to the highest rank cell site. If there are no other cell sites within radius R from the top ranked site, the search for other cell sites to collocate continues with the next highest ranked site. This process is repeated in a loop via processing block 28 until all top ranked cell sites under consideration have been used.

Processing block 29 in FIG. 2j again calculates the new RF coverage area from each carrier cell site considering the new co-lo location and new antenna heights. The output of this analysis is again placed into a mapping program to better show the total RF coverage in the geographic region of interest via processing block 30 that has resulted from the collocation decisions made by the process to this point in flowchart 200. The total RF coverage from the newly collocated sites is again calculated for the region of interest in processing block 31, and then compared to the original RF coverage area before the collocation process was started via processing block 32. Since it is expected that dropping some cell sites with collocation may reduce the total coverage area, we set a desired target for the maximum tolerable or desired decrease in coverage area. A reasonable percentage goal might be 80%. Obviously, there is a trade-off between the reduction of infrastructure cost and the reduction of total RF coverage. It may be that if the infrastructure cost attained through collocation is significant, then a 20% loss of total area coverage may still be attractive, especially if the 20% reduction in coverage area largely occurrs in a low population density area within the considered region. If the total new coverage after collocation does not meet the minimum 80% (or whatever is deemed appropriate), then processing block 33 increases (or decreases) the percentage of top ranked sites considered by, for example, 10%, so if we started by considering the top 40%, we could now increase this to 50% with the intent of getting better coverage. Since only 50% of the ranked sites are now in play, processing block 34 would pass control back to processing blocks 22-33. In this iteration that passes through processing block 33, if the test of processing block 34 indicates that all sites have been exhausted, and processing block 32 still shows that we are under the target coverage of 80% of the original coverage, then processing block 35 is used to fill-in coverage RF coverage holes using sites near areas lacking coverage—this is done until the minimum 80% coverage of the original is achieved. Once this is achieved, processing block 32 passes control to processing block 36 in FIG. 2L which calculates the percentage of RF coverage post collocation compared with the coverage pre-collocation for each carrier. In order to quantify the degree of new collocation achieved via this process, processing block 37 calculates the average number of carriers per site and also computes the percent reduction in total cell sites in the region under consideration. Finally, processing block 38 shows that iterating on different values of R km and Y % (% of original RF coverage area achieved after collocation), an optimum trade-off can be found for infrastructure cost reduction from collocation versus the final RF coverage area in the region under consideration.

Finally, processing block 39 in FIG. 2L shows some specific output results to demonstrate the collocation efficacy.

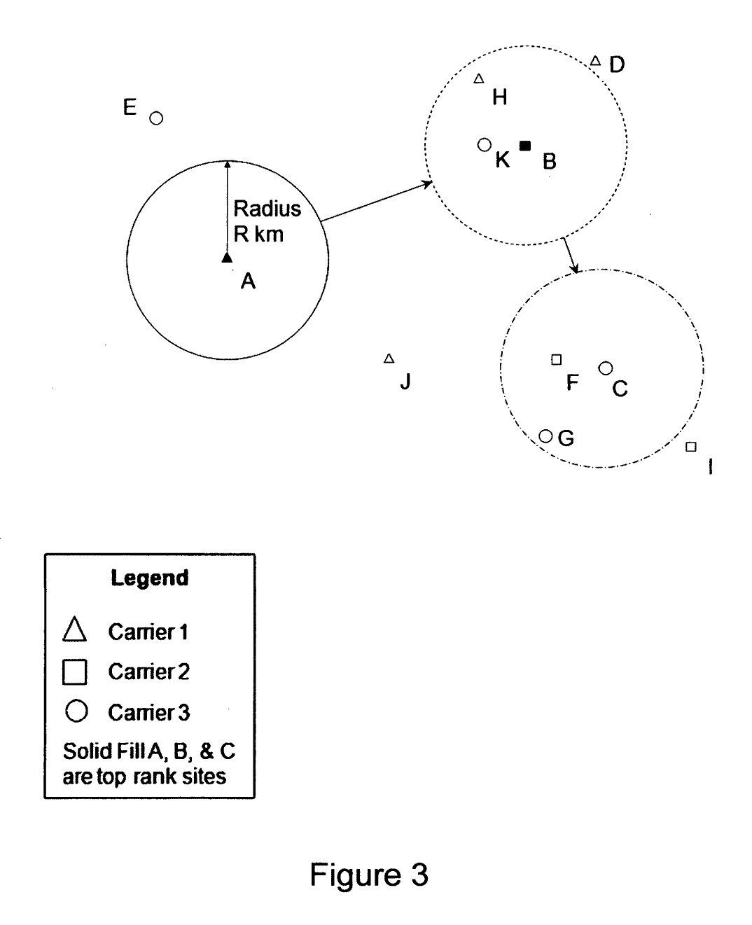

As a further example of a key part of the collocation process 200, FIG. 3 shows an example region with three different carriers. Each circle has a radius of R km. The solid fill icons A, B, & C represent the top 3 ranked co-lo sites. Site A has no other carriers within R km to capture, so the algorithm moves on to the site with the 2^{nd} highest rank, B. Here, there are two other carriers within R that can be co-located to site B: K and H. Antennas heights for these carriers will be assigned below site B's antenna in increments of 10′. The next highest ranking site is C, which would absorb Carrier 2 at site F. However, since site G is the same carrier as site C, it will not be co-located, since it is assumed that Carrier 3 has two close cell sites to accommodate coverage issues and/or high traffic demand that requires more than one cell site. This type of process continues until certain key RF coverage criteria are met, which may eventually pick-up sites E, D, J, and I.

The terms used in the above description should not be construed to limit the invention to the specific embodiments disclosed in the specification and the claims. Rather, the scope of the invention is to be determined entirely by the following claims, which are to be construed in accordance with established doctrines of claim interpretation.

1. One or more non-transitory computer readable media having computer-usable instructions embodied thereon for performing a method to select cell site collocation, the method comprising:
Obtaining selection criteria for each cell site candidate, the criteria including the importance and relevance of each site candidate;
Determining a rank for each candidate based upon the obtained criteria; and
Selecting highly ranked sites as potential cell site collocation sites; and
Determining which other cell sites can be moved to the highly ranked collocation candidate sites; and
Determining a target area percentage of final RF coverage in a given region under consideration; and iterating the collocation consolidation process until this target coverage area percentage is reached.
